(19) United States
(12) Patent Application Publication
(10) Pub. No.: US 2013/0028674 A1
(43) Pub. Date: Jan. 31, 2013

(54) Drilling Device

(71) Applicants: Takahiro Okubo, Hitachinaka-shi (JP); Satoshi Abe, Hitachinaka-shi (JP); Kazutaka Iwata, Hitachinaka-shi (JP)

(72) Inventors: Takahiro Okubo, Hitachinaka-shi (JP); Satoshi Abe, Hitachinaka-shi (JP); Kazutaka Iwata, Hitachinaka-shi (JP)

(73) Assignee: Hitachi KoKi Co., Ltd., Tokyo (JP)

(21) Appl. No.: 13/636,098

(22) PCT Filed: Apr. 12, 2011
(86) PCT No.: PCT/JP2011/059470

§ 371 Date: Sep. 19, 2012

(30) Foreign Application Priority Data
Apr. 12, 2010 (JP) 2010-091047

(51) Int. Cl. B23B 49/00

(52) U.S. Cl. 408/16

(57) ABSTRACT

A drilling device drilling to a desired depth without a gauge. The drilling device includes a distance sensor positioned on an imaginary line spanning between a front end of the housing and a hand gripped portion. The distance sensor is away form a front end of a gear housing by a distance Ls. The distance sensor provides an effective measurement range. The relationship of L1≦Ls and Ls+Lb≦L2 is satisfied where L1 represents a distance between the distance sensor and a point closest to the distance sensor and defining a lower limit of the effective measurement range, L2 represents a distance between the distance sensor and a point farthest from the distance sensor and defining an upper limit of the effective measurement range, and Lb represents a distance between the front end of the housing and a tip end of the end bit.

### TECHNICAL FIELD

The present invention relates to a drilling device, and more particularly, to a drilling device capable of measuring a depth of a bore formed in a workpiece drilled by an end bit.

### BACKGROUND ART

A drilling device such as a hammer drill is known to form a bore in a workpiece by rotating a drill bit and by imparting an impact force on the drill bit. The drilling device includes, for generating the impacting force, a motor, a cylinder, a piston disposed in the cylinder, a motion converting mechanism for converting a rotation force of the motor to the reciprocal motion of the piston, an impact piece driven by the piston, and an intermediate piece against which the impact piece strikes. An end bit is assembled at a tip end portion of the drilling device. Upon impingement of the impact piece onto the intermediate piece, the impacting force is transmitted to the end bit through the intermediate piece. Further, rotation of the motor is transmitted to the end bit, so that the end bit is rotated about its axis.

The drilling device also includes a gauge extending in a direction parallel to the extending direction of the end bit. The gauge has a tip end abuttable on a surface of the workpiece when the end bit reaches a desired depth, so that a user can recognize that the bore has a desired depth. Such hammer drill is disclosed in Japanese Patent Application Kokai No. 2009-241229.

### CITATION LIST

### Patent Literature

PTL1: Japanese Patent Application Kokai No. 2009-241229

### SUMMARY OF INVENTION

### Technical Problem

However, according to the conventional drilling device, the gauge is impeditive for drilling operation. Thus, it is an object of the present invention to provide a drilling device capable of permitting a user to recognize a drilling to a desired depth without provision of the gauge.

### Solution to Problem

This and other object of the present invention will be attained by a drilling device including a housing, a drive power source, a power transmission mechanism, and a distance sensor. The housing has a rear end portion and a front end portion to which an end bit is detachably attachable. The end bit is configured to form a bore in a workpiece. The drive power source is accommodated in the housing. The power transmission mechanism transmits a driving force generated in the power source to the end bit. The distance sensor is provided at the housing and is configured to measure a distance from the distance sensor to a surface of the workpiece. The distance sensor provides an effective measurement range capable of performing a measurement of a distance within a predetermined margin of error, as long as the surface of the workpiece positioned ahead of the housing is spaced away from the distance sensor within a predetermined region. Further, the relationship of L1≦Ls and Ls+Lb≦L2 is satisfied where Ls represents a distance in a frontward/rearward direction between a front end of the housing and the distance sensor, Lb represents a distance in the frontward/rearward direction between the front end of the housing and a tip end of the end bit, L1 represents the a distance in the frontward/rearward direction between the distance sensor and a point closest to the distance sensor and defining a lower limit of the effective measurement range, and L2 represents a distance in the frontward/rearward direction between the distance sensor and a point farthest from the distance sensor and defining an upper limit of the effective measurement range.

With this structure, a fixing position of the distance sensor relative to the housing can be determined with reference to the front end position of the housing, and the thus position fixed distance sensor can perform distance measurement between the distance sensor and the surface of the workpiece within a predetermined margin of error. Further, a large distance between the front end of the end bit and the distance sensor can be provided by positioning the distance sensor at the rear side of the end bit. Therefore, this construction can prevent the cutting chips or dust from being deposited on the distance sensor, thereby enabling precise distance measurement.

Here, the drive power source includes a motor having an output shaft outputting a rotation force, and the drilling device further includes a fan rotatable integrally with a rotation of the output shaft. The housing is formed with a front side air passage that allows air blown from the fan to flow along a front portion of the distance sensor.

With this structure, the air blows off the cutting chips and dust to prevent the chips and dust from depositing on the surface of the distance sensor. Therefore, measurement error due to the deposition of the dust on the front surface of the distance sensor can be restrained to thus stabilize the measurement of distance during drilling operation.

Further, the drive power source includes a motor having an output shaft outputting a rotation force, and the drilling device further includes a fan rotatable integrally with a rotation of the output shaft. The housing is formed with a rear side air passage that allows air blown from the fan to flow along a rear portion of the distance sensor.

With this structure, air from the fan can effectively cool the distance sensor.

Further, the drive power source includes a motor. The housing includes a motor housing accommodating therein the motor, and a mechanism housing accommodating therein the power transmission mechanism. The distance sensor is fixed to the motor housing.

With this structure, since the vibration occurring in the motor housing is less than that occurring in the gear housing, measurement error due to the vibration can be reduced.

Further, the housing defines a center of gravity position, and the distance sensor is positioned on or adjacent to the center of gravity position. Therefore, a moment applied to the distance sensor and generated during the drilling operation can be reduced to a low level regardless of the attachment of the longest end bit or the shortest end bit to the drilling device. Consequently, error in measuring the distance by the distance sensor can be reduced into a predetermined margin, thereby enabling accurate distance measurement with the distance sensor. Further, impossibility in distance measurement due to extreme short distance between the distance sensor and the workpiece can be avoided.

Further, the housing includes a handle portion having a gripped portion held by a middle finger and an annular finger of the user. An imaginary line spans between the front end of the housing and the gripped portion, and the distance sensor is positioned on the imaginary line.

With this structure, a moment applied to the distance sensor and generated during the drilling operation can be reduced to a low level regardless of the attachment of the longest end bit or the shortest end bit to the drilling device. Consequently, error in measuring the distance by the distance sensor can be reduced into a predetermined margin, thereby enabling accurate distance measurement with the distance sensor. Further, impossibility in distance measurement due to extreme short distance between the distance sensor and the workpiece can be avoided. Further, bumping of the distance sensor against the workpiece or ambient component or cutting chip can be avoided. Therefore, breakdown of the distance sensor can be prevented.

Further, drilling device further includes an elastic member interposed between the housing and the distance sensor. The distance sensor is fixed to the housing through the elastic member. With this structure, vibration of the housing can be absorbed in the elastic member. Therefore, transmission of vibration occurring at the housing to the distance sensor can be restrained. Consequently, increase in margin of measurement error and breakdown of the distance sensor due to the vibration can be reduced.

### BRIEF DESCRIPTION OF DRAWINGS

In the drawings:

FIG. 1 is a cross-sectional view of a drilling device according to a first embodiment of the present invention;

FIG. 2 is an enlarged cross-sectional view showing an air passage in the drilling device according to the first embodiment;

FIG. 3 is a an enlarged cross-sectional view of a distance sensor in the drilling device according to the first embodiment;

FIG. 4 is a graphical representation showing a relationship between an effective measuring range and an output level in the drilling device according to the first embodiment; and

FIG. 5 is a cross-sectional view of a drilling device according to a second embodiment of the present invention.

### DESCRIPTION OF EMBODIMENTS

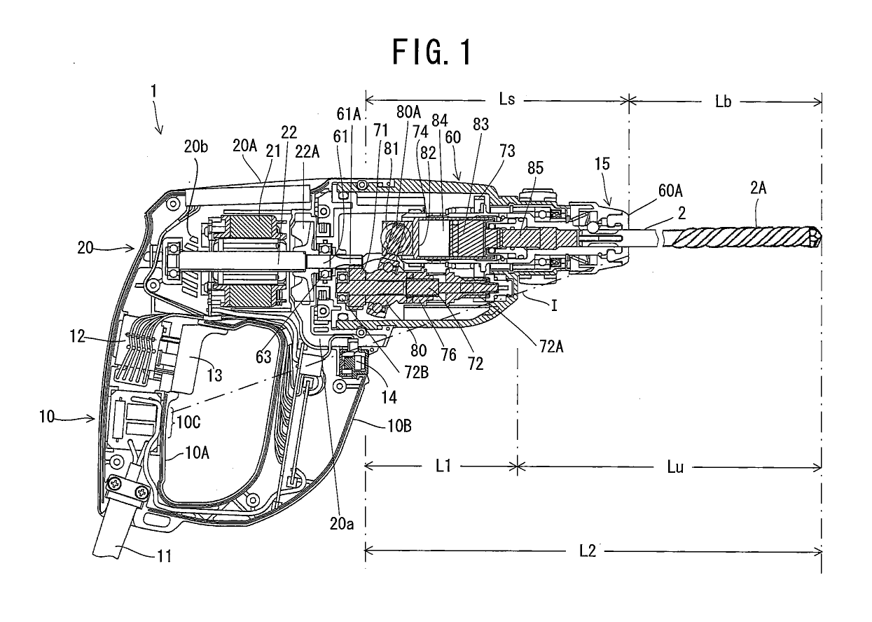

A drilling device according to a first embodiment of the present invention will be described with reference to FIGS. 1 through 4. As shown in FIG. 1, the drilling device 1 is a rotary hammer drill and includes a housing which is a combination of a handle portion 10, a motor housing 20, and a gear housing 60. Throughout the description, a left side, a right side, an upper side and a lower side in FIG. 1 will be referred to as a rear side, a front side, an upper side, and a lower side, respectively. A length of the housing spanning between a front end and a rear end of the housing, i.e., a length in the rightward/leftward direction in FIG. 1 is about 30 to 40 cm.

The handle portion 10 is generally U-shaped, and the motor housing 20 has a motor accommodating portion 20A accommodating a motor 21 (described later). The upper portion of the handle portion 10 is integral with the motor accommodating portion 20A and the handle portion 10 and motor housing 20 are made from a plastic material. The handle portion 10 can be a part of the motor housing 20. The handle portion 10 has a rear portion 10A whose lower portion is provided with a power cable 11. Further, a switching mechanism 12 is installed in the rear portion 10A. A trigger 13 manipulated by a user is mechanically connected to the switching mechanism 12. The power cable 11 is electrically connectable to an external power source (not shown) for supplying an electric current to the switching mechanism 12. Upon manipulation to the trigger 13, the switching mechanism 12 is connected to or disconnected from the external power source. A hand gripped portion 10C is defined in the rear portion 10A and immediately below the trigger 13. The hand gripped portion 10C is held by a middle finger and an annular finger of the user when the user grips the rear portion 10A of the handle portion 10.

A distance sensor 14 is provided at a front portion 10B of the handle portion 10. More specifically, the distance sensor 14 is positioned at an upper portion of the front portion 10B, and is configured to measure a distance between the distance sensor 14 and a workpiece positioned in confrontation with the distance sensor 14 in a direction from the rear side to the front side. The distance sensor 14 is positioned on or adjacent to a center of gravity of the drilling device 1 except the power cable 11 and an end bit 2 (described later). The center of gravity can also be defined by a total weight of the housing and its internal components. More specifically, The position of the distance sensor 14 is on an imaginary linear line spanning between the hand gripped portion 10C of the rear portion 10A of the handle portion 10 and a tip end portion 60A of the gear housing 60, i.e., a tip end portion of the drilling device 1. Further, the distance sensor 14 is spaced away from the tip end portion 60A by a distance of “Ls”. In other words, a distance between a front end of the distance sensor 14 and the tip end portion 60A is “Ls”.

As shown in FIG. 3, approximately entire portion of the distance sensor 14 is covered with a resin cover 14A. The resin cover 14A has a rear portion provided with an elastic member 14B made from a rubber which is fixed to an upper portion of the front portion 10B of the handle portion 10. The distance sensor 14 is electrically connected to a microcomputer (not shown) to which the motor 21 (described later) is connected. Further, the distance sensor 14 is electrically connected to an input portion (not shown) at which a desired bore depth can be input. The input bore depth can be in a range of from 5 cm to 6 cm.

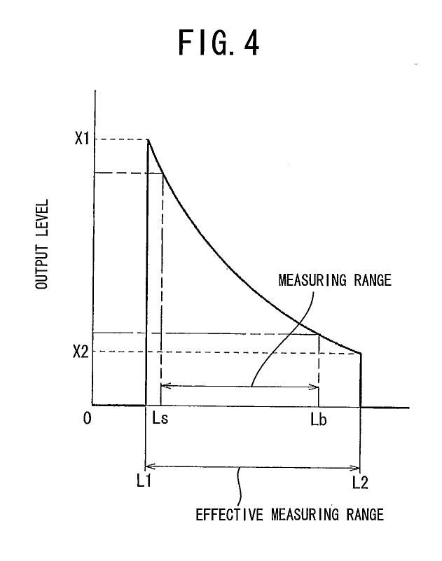

The distance sensor 14 is an infrared radiation sensor. Wavelength of the infrared ray is about 850 nm, and the distance sensor 14 provides an effective measurement range. More specifically, as shown in FIG. 4, a stable and constant voltage of the sensor 14 cannot be output as an output level based on the distance from the distance sensor 14, if the distance from the distance sensor 14 is less than “L1”, and therefore, the output is unstable to cause a large margin of error on the distance level. Consequently, distance measurement within a predetermined margin of error cannot be performed. On the other hand, a voltage of the sensor 14 is extremely low as the output level based on the distance from the distance sensor 14, if the distance from the distance sensor 14 is greater than “L2”, and therefore, resolution performance is low, and large margin of error on the distance is provided. Consequently, distance measurement within a predetermined margin of error cannot be performed.

In view of the above, an effective measurement range “Lu” in the frontward/rearward direction can be determined at a position ahead of the distance sensor 14. In the effective measurement range, the closest distance from the distance sensor 14 is “L1”, and the farthest distance from the distance sensor 14 is “L2”. Distance measurement within a margin of error of plus minus 1.5 mm can be performed if a surface of the workpiece is positioned within “Lu”. The following relationship can be established among L1, L2, Ls and Lb (Lb will be described later): L1≦Ls, and Ls+Lb≦L2. The effective measurement range is about 70 cm in the frontward/rearward direction, L1 is about 10 cm, and L2 is about 80 cm.

The motor 21 such as AC brushless motor is accommodated in the motor housing 20. The motor 21 is subjected to rotation control through the microcomputer (not shown). The motor 21 has an output shaft 22 outputting a rotational driving force. An axial flow fan 22A is concentrically provided to a base end portion of the output shaft 22, and is rotatable together with the output shaft 22.

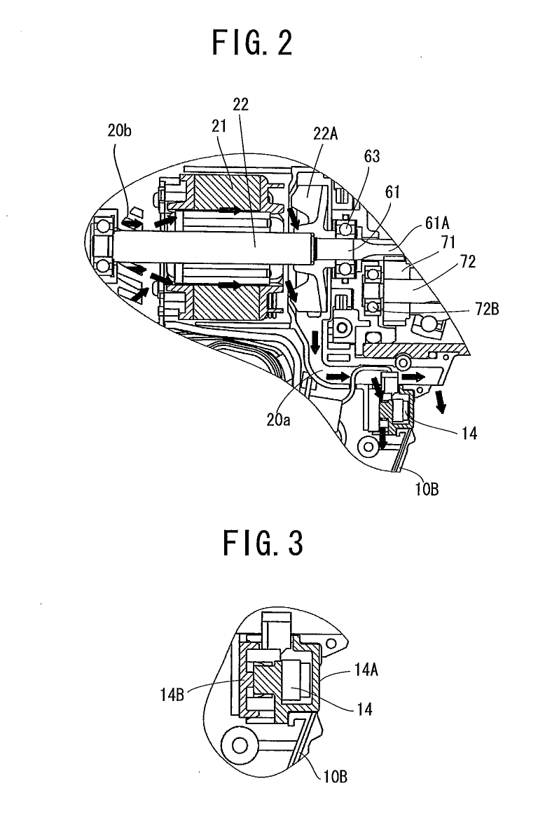

An air passage 20a is defined at a position below the axial flow fan 22A. The air passage 20a extends downward and is then frontward to communicate with spaces at positions above, front side and rear side of the distance sensor 14. An air intake port 20b is formed at the rear portion of the motor housing 20. Upon rotation of the axial flow fan 22A, air introduced into the motor housing 20 through the air intake port 20b flows near the motor 21 through the air passage 20a and passes along the upper side and rear side of the distance sensor 14 as indicated by an arrow in FIG. 2 for cooling the distance sensor 14. Further, the air also flows along the front side of the distance sensor 14 to prevent the dust or cutting chips from being deposited on the distance sensor 14. The air passage 20a corresponds to a front side air passage and a rear side air passage.

The gear housing 60 is a resin molded product and positioned at a front side of the motor housing 20. In the gear housing 60, a first intermediate shaft 61 extends coaxially and integrally with the output shaft 22 and is rotatably supported by a bearing 63. That is, the first intermediate shaft 61 has a rear end integrally connected to the output shaft 22. The first intermediate shaft 61 has a front end portion provided with a fourth gear 61A. A second intermediate shaft 72 is provided in the gear housing 60 and extends in parallel to the motor 21. The second intermediate shaft 72 is rotatable about its axis and supported by a bearing 72B.

The second intermediate shaft 72 has a rear end portion provided with a fifth gear 71 meshedly engaged with the fourth gear 61A. The second intermediate shaft 72 has a front end portion formed with a gear portion 72A meshedly engaged with a sixth gear 73 (described later). In the gear housing 60, a cylinder 74 is provided at a position above the second intermediate shaft 72. The cylinder 74 extends in a direction parallel to the second intermediate shaft 72 and is rotatably supported to the gear housing 60. The sixth gear 73 is concentric with the cylinder 74 and is fixed to an outer peripheral surface of the cylinder 74. Because of the meshing engagement between the sixth gear 73 and the gear portion 72A, the cylinder 74 is rotatable about its axis.

A bit holder 15 is provided at a front side of the cylinder 74 for detachably holding the end bit 2. The second intermediate shaft 72 has an intermediate portion engaged with a clutch 76 with a spline and biased rearward by a spring. A change lever (not shown) connected to the clutch 76 is provided at the gear housing 60, so that the clutch 76 is shiftable between a hammer drill mode and a drill mode by manipulating the change lever. A motion converting mechanism 80 is rotatably disposed over the second intermediate shaft 72 at a position beside the clutch 76 (a motor side of the clutch 76) for converting the rotary motion into a reciprocating motion. The motion converting mechanism 80 has an arm 80A reciprocally movable in the frontward/rearward direction of the drilling device 1 by the rotation of the second intermediate shaft 72.

The end bit 2 is a drill bit having a drill 2A at its tip end portion as shown in FIG. 1. A bore is formed in a workpiece by rotating and linearly moving the end bit 2. The end bit 2 is detachably held to the bit holder 15, and is exchangeable with a new end bit 2. Various end bits 2 having longitudinal length ranging from 90 mm to 450 mm are available. Other configuration is available instead of the drill 2A. Here, “Lb” is defined which is a distance between the tip end portion 60A of the gear housing 60 and a front end of the end bit 2 assembled to the bit holder 15, assuming that the end bit 2 is the longest end bit among those assembleable to the bit holder 15.

When the clutch 76 is shifted to the hammer drill mode, the second intermediate shaft 72 is mechanically connected to the motion converting mechanism 80 by the clutch 76. A piston 82 is reciprocally movable in the cylinder 74 and slidable therewith in a direction parallel to the second intermediate shaft 72, and the piston 82 is moved in interlocking relation to the motion converting mechanism 80 by way of a piston pin 81. An impact piece 83 is movably disposed in the cylinder 74, and an air chamber 84 is defined in the cylinder 74 and between the piston 82 and the impact piece 83. An intermediate piece 85 is slidably supported in the cylinder 74. The intermediate piece 85 is positioned opposite to the air chamber 84 with respect to the impact piece 83, and is movable in the moving direction of the piston 82. The end bit 2 is positioned opposite to the impact piece 83 with respect to the intermediate piece 85. Thus, the impact piece 83 applies impacting force to the end bit 2 through the intermediate piece 85.

Rotation of the motor 21 is transmitted to the second intermediate shaft 72 through the first intermediate shaft 61, the fourth gear 61A, and the fifth gear 71, and the rotation of the second intermediate shaft 72 is transmitted to the cylinder 74 by the meshing engagement between the gear portion 72A and the sixth gear 73 to rotate the end bit 2. Upon shifting the clutch 76 to the hammer drill mode, the clutch 76 is coupled to the motion converting mechanism 80 to transmit the rotation of the second intermediate shaft 72 to the motion converting mechanism 80, and the rotation is converted to the reciprocal motion of the piston 82 by way of the piston pin 81. Reciprocation of the piston 82 causes repeated increase and decrease in air pressure at the air chamber 84 defined between the piston 82 and impact piece 83 to thus impart impacting force on the impact piece 83. The impact piece 83 strikes against the rear surface of the impact piece 83 as a result of forward movement of the impact piece 83, so that the impacting force is applied to the end bit 2 through the intermediate piece 85. In this way, rotation force and impacting force are simultaneously applied to the end bit 2 in the hammer drill mode.

When the clutch 76 is at the drill mode, the clutch 76 shuts off the connection between the second intermediate shaft 72 and the motion converting mechanism 80, so that only the rotation force of the second intermediate shaft 72 is transmitted to the cylinder 74 by way of the gear portion 72A and the sixth gear 73. Thus, only the rotation force is imparted on the end bit 2.

For forming a bore in the workpiece, a user inputs a desired bore depth through the input portion (not shown), and then operates the trigger 13. When the end bit 2 reaches the desired bore depth, the depth is detected by the distance sensor 14 and a signal indicative of the detected depth is transmitted to the microcomputer (not shown). Upon receipt of the signal, microcomputer stops rotation of the motor 21 to avoid further drilling operation.

The distance sensor 14 provides an effective measurement range such that the distance between the front end portion 60A of the housing and the distance sensor 14 is “Ls”, and the relationships of L1≦Ls and Ls+Lb≦L2 are satisfied. Therefore, fixed position of the distance sensor 14 relative to the housing can be determined, based on the distance from the front end portion 60A of the housing. With such distance sensor 14 thus positioned, a distance between the distance sensor 14 and the surface of the workpiece (a bottom surface of the bore) can be measured within a predetermined margin of error.

Further, since the housing defines therein the air passage 20a through which air from the axial flow fan 22A flows along the front portion of the distance sensor 14, the air blows off the cutting chips and dust to prevent the chips and dust from depositing on the surface of the distance sensor 14. Therefore, measurement error due to the deposition of the dust on the front surface of the distance sensor 14 can be restrained to thus stabilize the measurement of distance during drilling operation. Further, cooling to the distance sensor 14 can be achieved by the air from the axial flow fan 22A.

Further, the distance sensor 14 is not fixed to the gear housing 60 but is fixed to the motor housing 20. Since the vibration occurring in the motor housing 20 is less than that occurring in the gear housing 60, measurement error due to the vibration can be reduced, and further, breakdown of the distance sensor 14 due to the vibration can be prevented.

Further, the distance sensor 14 is positioned on or near the center of gravity position of the housing, and the distance sensor 14 is positioned on the imaginary line spanning between the front end portion of the housing and the hand gripped portion 10C. Therefore, a moment applied to the distance sensor 14 and generated during the drilling operation can be reduced to a low level regardless of the attachment of the longest end bit or the shortest end bit to the bit holder 15 as long as the length Lb is satisfied with the above described relationship. Consequently, error in measuring the distance by the distance sensor 14 can be reduced into a predetermined margin, thereby enabling accurate distance measurement with the distance sensor 14. Further, impossibility in distance measurement due to extreme short distance between the distance sensor 14 and the workpiece can be avoided, since the distance sensor 14 is spaced away from the front portion of the housing by a distance L1.

Further, bumping of the distance sensor 14 against the workpiece or ambient component or cutting chip can be avoided, since the distance sensor 14 is guarded by the handle portion 10 and the motor housing 20. Therefore, breakdown of the distance sensor 14 can be prevented.

Further, since the distance sensor 14 is fixed to the housing through the elastic member 14B, vibration of the housing can be absorbed in the elastic member 14B. Therefore, transmission of vibration occurring at the housing to the distance sensor 14 can be restrained. Consequently, increase in margin of measurement error and breakdown of the distance sensor 14 due to the vibration can be reduced.

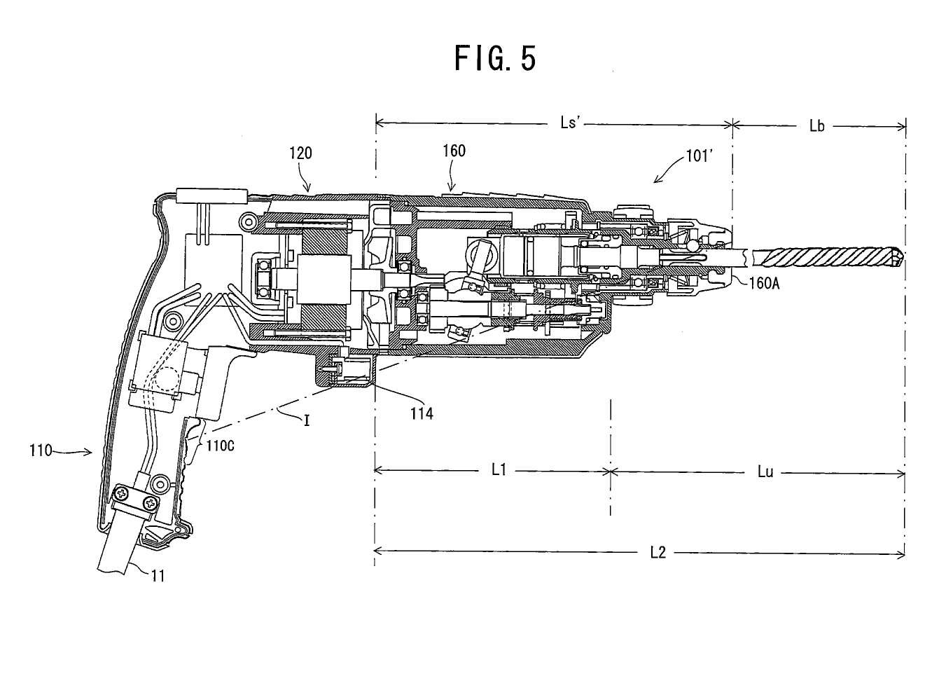

A drilling device according to a second embodiment of the present invention will next be described with reference to FIG. 5. In the first embodiment, the handle portion 10 is U-shaped, and the distance sensor 14 is provided at the front portion 10B of the handle portion 10. On the other hand, in the second embodiment, a handle portion 110 is I-shaped. A distance sensor 114 is provided to a motor housing 120 at a portion adjacent to a gear housing 160. Further, the distance sensor 114 is positioned on or adjacent to a center of gravity of the drilling device 101 except the power cable 11 and the end bit 2. The center of gravity can also be defined by a total weight of the housing (a combination of the handle portion 110, the motor housing 20, and the gear housing 160) and its internal components. Further, the position of the distance sensor 114 is on an imaginary linear line “I” spanning between a hand gripped portion 110C of the rear portion 10A of the handle portion 110 and a tip end portion 160A of the gear housing 160, i.e., a tip end portion of the drilling device 1. Further, the distance sensor 114 is spaced away from the tip end portion 160A by a distance of Ls′. In other words, a distance between a front end of the distance sensor 114 and the tip end portion 160A is Ls′.

The present invention is available to a various device other than the drilling device such as a rotary hammer drill as long as the device employs an end bit for forming a bore in the workpiece.

While the invention has been described in detail and with reference to the specific embodiments thereof, it would be apparent to those skilled in the art that various changes and modifications may be made therein without departing from the scope of the invention.

### INDUSTRIAL APPLICABILITY

The present invention is particularly available for the drilling device such as a hammer drill capable of forming a bore having a desired depth.

### REFERENCE SINGS LIST

1 Drilling device

2 End bit

14 Distance sensor

20 Motor housing

21 Drive power source

60 Gear housing

1. A drilling device including:
a housing having a rear end portion and a front end portion to which an end bit is detachably attachable, the end bit being configured to form a bore in a workpiece;
a drive power source accommodated in the housing; and
a power transmission mechanism transmitting a driving force generated in the power source to the end bit; characterized by
a distance sensor provided at the housing and configured to measure a distance from the distance sensor to a surface of the workpiece, characterized in that
the distance sensor provides an effective measurement range capable of performing a measurement of a distance within a predetermined margin of error, as long as the surface of the workpiece positioned ahead of the housing is spaced away from the distance sensor within a predetermined region; and
the relationship of L1≦Ls and Ls+Lb≦L2 is satisfied where Ls represents a distance in a frontward/rearward direction between a front end of the housing and the distance sensor, Lb represents a distance in the frontward/rearward direction between the front end of the housing and a tip end of the end bit, L1 represents the a distance in the frontward/rearward direction between the distance sensor and a point closest to the distance sensor and defining a lower limit of the effective measurement range, and L2 represents a distance in the frontward/rearward direction between the distance sensor and a point farthest from the distance sensor and defining an upper limit of the effective measurement range.

2. The drilling device as claimed in claim 1, characterized in that the drive power source comprises a motor having an output shaft outputting a rotation force;
the drilling device further comprises a fan rotatable integrally with a rotation of the output shaft; and
the housing is formed with a front side air passage that allows air blown from the fan to flow along a front portion of the distance sensor.

3. The drilling device as claimed in claim 1, characterized in that the drive power source comprises a motor having an output shaft outputting a rotation force,
the drilling device further comprises a fan rotatable integrally with a rotation of the output shaft; and
the housing is formed with a rear side air passage that allows air blown from the fan to flow along a rear portion of the distance sensor.

4. The drilling device as claimed in claim 1, characterized in that the drive power source comprises a motor; and
the housing comprises a motor housing accommodating therein the motor, and a mechanism housing accommodating therein the power transmission mechanism, the distance sensor being fixed to the motor housing.

5. The drilling device as claimed in claim 1, characterized in that the housing defines a center of gravity position, and
the distance sensor is positioned on or adjacent to the center of gravity position.

6. The drilling device as claimed in claim 1, characterized in that the housing comprises a handle portion having a gripped portion held by a middle finger and an annular finger of the user, an imaginary line spanning between the front end of the housing and the gripped portion; and
the distance sensor is positioned on the imaginary line.

7. The drilling device as claimed in claim 1, characterized by an elastic member interposed between the housing and the distance sensor, the distance sensor being fixed to the housing through the elastic member.
